(19) United States
(12) Patent Application Publication
(10) Pub. No.: US 2018/0155084 A1
(43) Pub. Date: Jun. 7, 2018

(54) Flat Patch Bottom Self Opening Style Bag and Method of Manufacture

(71) Applicant: Gateway Packaging Company, White House, TN (US)

(72) Inventor: Omar Abuaita, Nashville, TN (US)

(73) Assignee: Gateway Packaging Company, White House, TN (US)

(21) Appl. No.: 15/726,799

(22) Filed: Oct. 6, 2017

Related U.S. Application Data
(60) Provisional application No. 62/405,403, filed on Oct. 7, 2016.

(51) Int. Cl. B65D 30/08; B65D 30/20; B65D 30/18; B31B 70/26; B31B 70/64; B31B 70/66; B31B 70/00

(52) U.S. Cl. CPC B65D 31/04; B65D 31/10; B65D 31/02; B65D 31/08; B31B 2155/003; B31B 70/649; B31B 70/66; B31B 70/008; B31B 70/26

(57) ABSTRACT

A method of manufacturing an SOS bag of indefinite length is disclosed including, as a preliminary step, providing a gusseted tube of indefinite length. In a series of steps, the gusseted tube may be folded inwardly at its base to create front and rear flaps that are then folded about fold lines to create a folded bottom gusseted tube. A rectangular patch may then be applied thereto in a series of steps, including for example hot air welding and/or ultrasonic welding, to complete an embodiment of a bag of the disclosure, one having a unique bottom for an SOS bag. The disclosure additionally includes bags manufactured by the method disclosed herein, as well as SOS bags having the unique construction disclosed herein.

### PRIORITY CLAIM

This application claims priority to co-pending U.S. provisional patent application 62/405,403, filed on Oct. 7, 2016.

### FIELD OF DISCLOSURE

A new gusseted self-opening style bag with a unique bottom construction is disclosed, the bag manufactured via a new manufacturing process.

### BACKGROUND

The statements in this section merely provide background information related to the disclosure and do not necessarily all constitute prior art.

The prior art includes a bag known as an SOS bag. Opinions differ on what SOS abbreviates, though it is commonly considered an abbreviation of Self Opening Style. Other interpretations of SOS include Self Opening Sack, Self Opening Square, and Self Opening Satchel. Regardless, an SOS bag as described herein is generally understood to be a gusseted bag including front and back panels joined by gussets, where the bag may be opened from a flat folded orientation to reveal a substantially flat rectangular bottom. When the bag is opened, the gussets may be unfolded and serve as side walls that, in conjunction with the front and back panels of the bag, as well as the rectangular bottom, define the general structure of the bag. A ubiquitous SOS bag of the prior art might include, by way of illustrative example, a simple single-layer brown paper lunch sack.

In the packaging industry, it is common for the top of the SOS bag to be filled with consumer goods, followed by the closure of the top of the bag to contain the goods. This closure can be done in a variety of manners, including applying adhesive or other seal to the top of the bag and rolling the bag closed to complete a top seal of the bag. In other applications, a reclosure apparatus, such as a resealable zipper profile with complementary interlocking features or a hook and loop type reclosure mechanism, for example, may be mounted atop the bag. In other applications, a heat or ultrasonic seal could be applied across the top of the bag.

Rectangular bottom, gusseted bags made substantially of plastic material exist in the art, though those bags are substantially distinct from the bags of this disclosure, specifically in that they are not traditional SOS bags. For example, some rectangular bottom gusseted bags of the prior art, such as those manufactured on box pouch machines, are not made from a gusseted tube. Rather, they are from one or more webs of material that are folded and sealed together into the general shape of a bag. These prior art bags are folded, heat sealed, and then trimmed to give flush edges around the folds and seams of the gussets, side walls, and bottoms, creating substantial waste. One of skill in the art will appreciate the numerous distinctions between a pouch-style bag and a bag that will be disclosed herein.

### SUMMARY

This section provides a general summary of the disclosure, and is not intended to provide a comprehensive disclosure of its full scope or all of its features.

This disclosure includes method of manufacturing a new SOS bag including, as a preliminary step, providing a gusseted tube of indefinite length. In a series of steps, the gusseted tube may be folded and sealed, and a rectangular patch bottom applied and sealed thereto, to create a unique bottom for an SOS bag. Other sealing mechanisms and a variety of bag material constructions are disclosed.

The disclosure additionally includes bags manufactured by the method disclosed herein, as well as SOS bags having the unique construction disclosed herein.

### BRIEF DESCRIPTION OF THE FIGURES

The drawings described herein are for illustrative purposes only of selected embodiments and not all possible implementations, and are not intended to limit the scope of the present disclosure.

FIG. 1, which shows prior art, is a perspective view of a conventional SOS bag, this bag open and resting upright on its bottom.

FIG. 2, which also shows prior art, is a view of the conventional SOS bag of FIG. 1, this particular view showing the bag folded and laying down, with the bottom of the bag visible.

FIG. 3 shows an embodiment of the creation of the gusseted tube of material into which a bag of the disclosure will be made, this figure showing an embodiment of sealing of the overlap of the bag panel.

FIG. 4 shows an embodiment of a gusseted tube of material of an indefinite length.

FIG. 5 shows an embodiment of a die cut layout of an unfolded bag of the disclosure, this layout showing a step cut top.

FIG. 6 shows an embodiment of a die cut layout of an unfolded bag of the disclosure, this layout showing a Z cut top.

FIG. 7 shows an embodiment of the bottom of the gusseted tube of FIG. 4, where the gussets have been inwardly folded towards the interior of the bag, where front and rear flaps are visible.

FIG. 8 shows the embodiment of the bottom of the gusseted tube of FIG. 7, the front flap having been folded towards the interior of the bag about a front flap fold line, including an optional spot of hot melt or glue.

FIG. 9 shows the embodiment of the bottom of the gusseted tube of FIG. 8, the rear flap having been folded towards the interior of the bag about the rear flap fold line.

FIG. 10 shows the configuration and presentation of the gusseted tube of FIG. 9 in a T shape to a sealing apparatus, in a step of an embodiment of the bag manufacturing process.

FIG. 11 shows the positioning and direction of application of a flat bottom rectangular patch to the gusseted tube of FIG. 10, as well as the relative geometries of the patch and the bottom of the gusseted tube.

FIG. 12 shows an embodiment of heat sealing the patch in a first sealing direction onto the bottom of the gusseted tube, via hot air sealing.

FIG. 13 shows an embodiment of the patch and a first pair of heat seals, having been sealed onto the bottom of the gusseted tube in the first sealing direction, as well as an embodiment of a rotation of the patch and gusseted tube for a subsequent step.

FIG. 14 shows a partial close up of an embodiment of the patch and a second pair of heat seals, these heat seals in this embodiment being created via ultrasonic welding, having been sealed onto the bottom of the gusseted tube in the second sealing direction.

FIG. 15 shows an embodiment of a profile view of the flat bottom of the gusseted tube and a pair of ultrasonic welding stations applying the second pair of heat seals to the patch and the bottom of the tube.

FIG. 16 shows an embodiment of a completed bag of the disclosure, viewed from the bottom of the bag, with details of the four heat seals.

FIG. 17 shows an embodiment of a series of completed bags of the disclosure as displayed on retail shelving for viewing by consumers.

Corresponding reference numerals indicate corresponding parts throughout the several views of the drawings.

### DETAILED DESCRIPTION

The following description of various embodiments is merely exemplary in nature and is in no way intended to limit the invention, its application, or its uses. Areas of applicability will become apparent from the description provided herein.

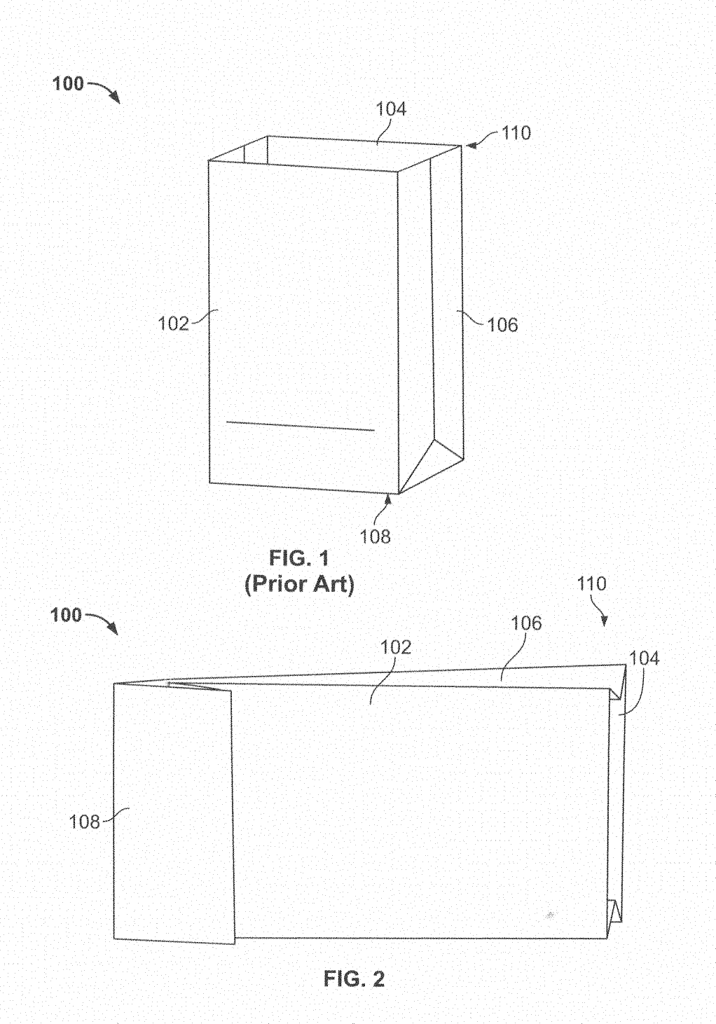

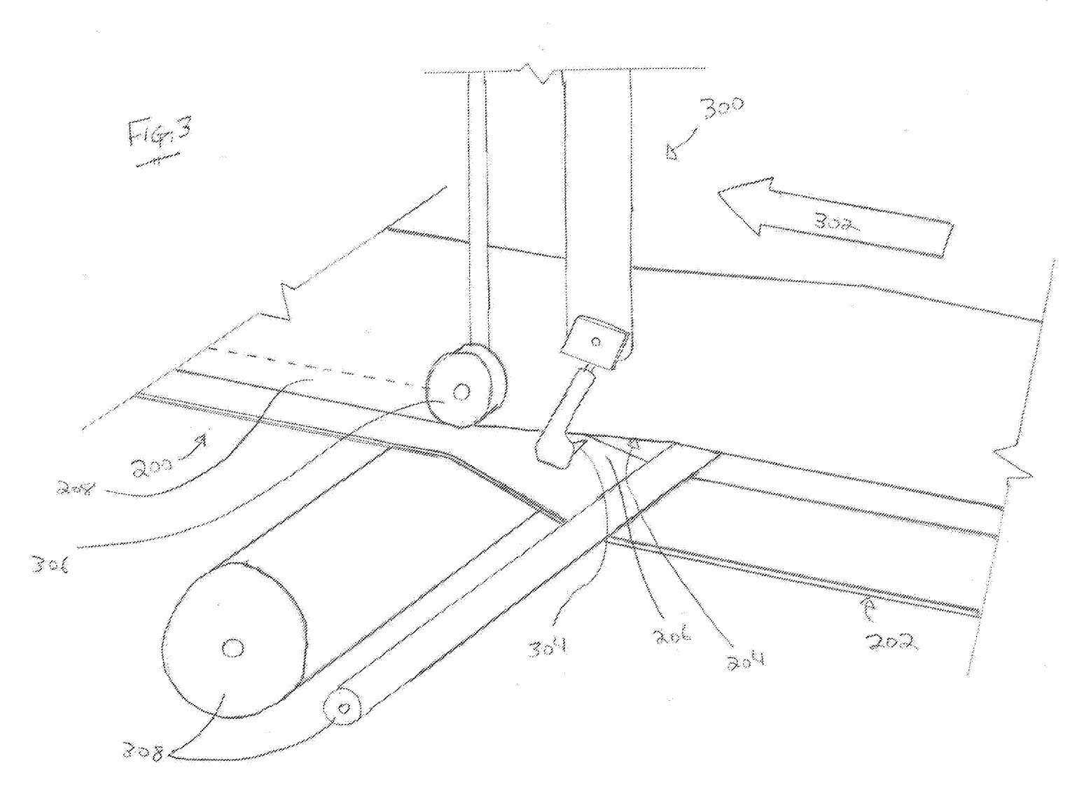

A new SOS bag with a unique bottom, as well as a method of making the same, is disclosed. A typical SOS bag 100, as seen in FIG. 1, includes a front panel 102, a back panel 104, and two gusseted side panels 106 joining the front and back panels, to create a tube having an inside and an outside. A length of tube may be folded and sealed at one end to create a bottom 108, thereby forming an SOS bag. The unfolded, open end of the tube may be referred to as the top 110 of the bag or the open end of the bag. The SOS bag of FIG. 1 is unfolded and opened upright, while the SOS bag of FIG. 2 is folded substantially flat. A bag of the disclosure will resemble the prior art SOS bag of FIGS. 1 and 2, with the distinction that the bottom of the bag of the disclosure includes a unique construction manufactured via a unique method, as will now be explained.

A bag of the disclosure may be constructed from a gusseted tube of material of indefinite length.

The tube, and hence the bag, may be constructed of a variety of materials, including but not limited to a multi-layer construction. A multi-layer construction, for example, may include plastic film on the inner-most layer on the inside of the bag. Other layers may include printed paper, such as printed clay coated paper, one or more additional film layers, including an exterior film layer, a kraft paper layer, and a variety of other layers of material. Various other layers known to those of skill in the art of construction of multi-layered bags may be implemented to make a bag as disclosed herein.

Where the multi-layer construction includes an inner plastic film layer and a middle paper layer, those layers may be adhered together via a hot melt adhesive. Where the multi-layer construction includes an outer plastic film layer and a middle paper layer, those layers may also be adhered together via a hot melt adhesive. Where the SOS bag is multi-layered, the layers may themselves be adhered together in a variety of manners, including a flood coat of hot melt adhesive between the layers.

In an embodiment, a film layer may be adhered to any adjacent layer via laminating the film to said layer. For example, an inner plastic film layer may be laminated to a middle clay coated paper layer, and an outer film layer may be laminated to said middle clay coated paper layer.

The tube may, in an embodiment, be a single layer of plastic material, or alternatively a web of multi-layered plastic may be laminated together to form an effectively single ply such that the individual layers are not distinguishable or independently manipulable. This is distinct from the, for example, multi-layered construction that includes an inner plastic film layer, a middle kraft paper layer, and an outer printed clay coated paper layer, where each of those layers is still recognizable and distinct, and might be at least partially independently manipulated via bag manufacturing machinery.

In an embodiment of an effectively single ply plastic laminate, an inner layer of woven oriented polypropylene may be laminated to an outer layer of reverse printed oriented polypropylene to make an effectively single layer web of material. Reverse-printed is understood to mean a substantially transparent or translucent plastic film that has been printed with backwards text and/or imagery that is visible through the plastic film such that the text and/or imagery is legible, i.e. not backwards, when viewed from the side of the film opposite from where it has been printed. Alternatively, an inner non-woven plastic film layer and an outer reverse printed plastic layer may be laminated together to form an effectively single layer web of material. Additionally, a single ply of plastic film may be used to make a bag as disclosed herein. Where heat seals are used, as opposed to seals effected via glue or hot melt adhesive, a plastic-to-plastic bond may be used, where one plastic film or layer would be bonded to an adjacent plastic film or layer.

These non-limiting examples and others are fully embraced by the scope of this disclosure as the construction material into which a bag of the disclosure is made by the methods disclosed herein.

The gusseted tube of indefinite length into which a bag of the disclosure may be made can be created in a variety of ways. In an embodiment, a substantially continuous sheet of material having a consistent width and an indefinite length may be fed along a machine and by its length and manipulated and folded onto itself across its width to create an overlap of material. At the overlap, the material may be sealed to itself to create a tube of material. This folding may include folding to create gussets that run the length of the material to create the gusseted tube, where the folding of the gussets may happen before, after, or in substantial synchronization with the sealing of the material.

Where the sheet of material is fed along a machine, the material may be fed, for example, from a spool of material, or from an apparatus that creates plastic sheeting from raw plastic materials such as pellets. Or, in another embodiment, the material may be fed from a series of spools and laminated together to turn a multi-layer construction into an effectively single layer construction.

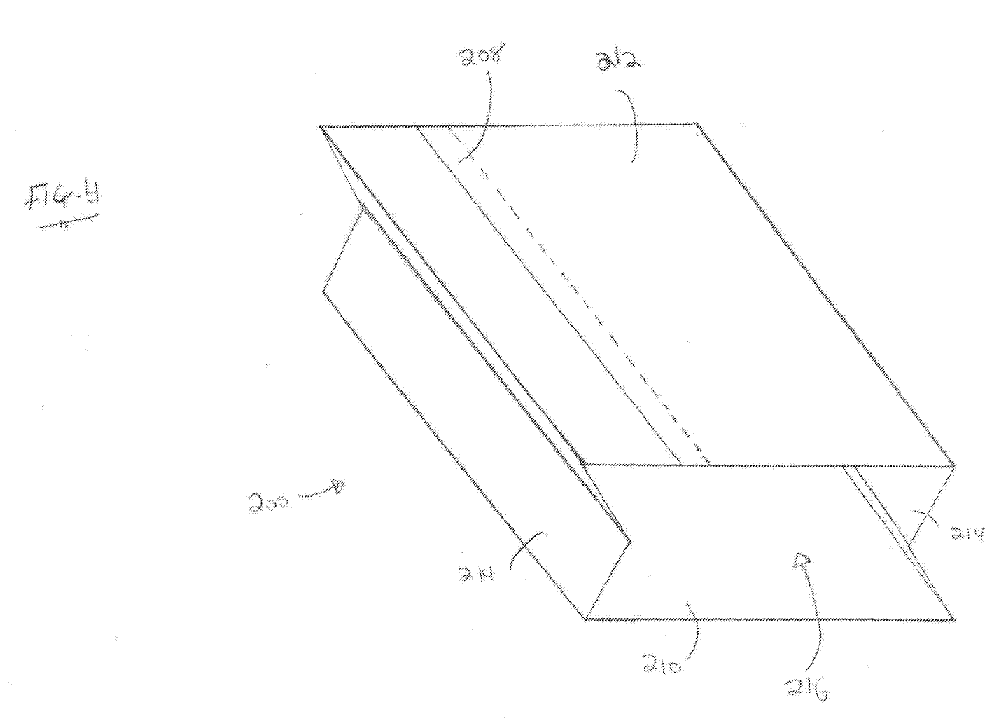

FIG. 3 shows an example of a method of creating a gusseted tube 200. Specifically, FIG. 3 shows a portion of material that has been folded to create gussets 202 as well as a heat sealing apparatus 300 operating on a machine where the tube is moving in a first direction 302 relative to the stationary heat sealing apparatus. In this embodiment, the seal is being created by selective application of hot air via a nozzle 304 onto an inner edge 204 of the material as the tube 200 moves in the first direction 302. As the tube continues along the machine in the first direction, the now at least slightly molten plastic material that comprises the inner edge 204 of the material is pressed against a corresponding outer edge of material 206 to provide compression and thereby adhere the two edges together and create an overlap 208, which may be referred to as a side seam. The pressing may be effected by, for example, a roller 306 in close proximity to a hot air nozzle. The tube may be manipulated in this method via various subsequent rollers 308 known in the art of bag manufacturing. In this way, the tube 200 may be completed, and the side seam 208 runs the length of the tube and is substantially parallel to the folds that define the front and back panels and the gussets. It should be noted that the selective hot air is applied in this embodiment to the inner edge of the overlapping material and not to the outer edge of material being overlapped, as the outer edge in this example is adjacent to the flat folded gussets. If the hot air was to be applied to the outer edge, being adjacent to the flat folded gussets, then, depending on various factors including the construction of the material and the geometry of the gussets relative to the side seam, the manufacturer runs the risk of undesirably heat sealing the gussets, resulting in a non-functional gusset and bag.

In an alternative embodiment, the material may be cut into planar segments of material of substantially equal lengths and then folded and sealed along an overlap to create side seams as individual tube portions, as opposed to being sealed along an overlap in a sheet of indefinite length which is then separated into individual tube segments.

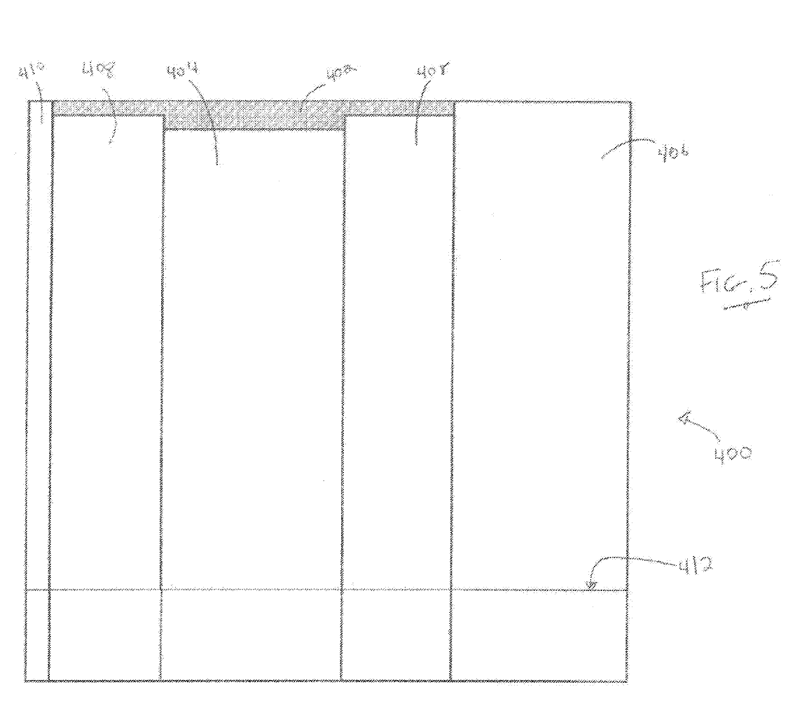

FIG. 4 shows an embodiment of a gusseted tube 200 of indefinite length that may be used to create a bag of the disclosure, this figure including detail of an embodiment of a side seam 208, including a side seam created via the aforementioned selectively applied hot air sealing method.

Although hot air sealing has been described, other sealing mechanisms may be used at various points of the manufacture of the bag of the disclosure. For example, ultrasonic sealing, also known as ultrasonic welding, is a method of applying high-frequency ultrasonic acoustic vibrations to a substrate to create a solid-state weld between two surfaces. This can be done selectively via an ultrasonic horn in combination with an anvil and wheel as the substrate moves in a lateral direction past the ultrasonic welding station. In another embodiment, a conventional heat bar may be used in some instances. A heat bar may be a heated element, often in the shape of a linear mass, such as a bar, to apply heat directly to a surface, thereby causing a brief molten state to a plastic material. In either instance, pressure in the form of, for example, a rolling mechanism could be used to press two surfaces together when one or more has received a sealing application to provide a snug seal between the surfaces. In another embodiment, a hot melt adhesive may be used to seal two surfaces, where a hot melt is an adhesive applied between surfaces that may then be pressed together. These and other mechanisms known in the art for sealing two surfaces of material are embraced by this disclosure.

Bags of the disclosure are manufactured in part via a new bottom assembly process that will be described hereinafter. However, the top of the bag may vary based upon the desires of the bag customer. The bag customer may be a dog food manufacturer, for example, who might want the top of the bag in one type of configuration or another. A flush cut bag is understood to mean a bag where the upper edges of the bag are substantially flush. In a flush cut bag, where the SOS bag is open and resting with the bottom of the bag on a horizontal surface, the upper edges of the bag generally define a horizontal plane parallel to the bottom of the bag. A step cut bag, by comparison, includes a first panel of a first height, gussets of a second height slightly shorter than the first panel height, and a second panel of a third height, slightly shorter than the gusset height. A Z cut bag, includes a first panel of a first height and a second panel of a second height, where the transition between the two panels along the gussets is a single diagonal cut that, when the tube and gussets are folded flat, resembles a Z or backwards Z, depending on which gusset is being viewed. Flush cut, step cut, and Z cut are all known terms to those of ordinary skill in the art with respect to gusseted bags. These and other tops, including those suitable for accepting various closure and reclosure apparatuses, are all embraced by this disclosure.

The gusseted tube of FIG. 4 includes a front panel 210 and a back panel 212, joined by two gussets 214, the tube having an interior cavity 216. Although in this figure a front and back have been assigned such that the seam is on the back panel, this disclosure is not intended to be so limiting.

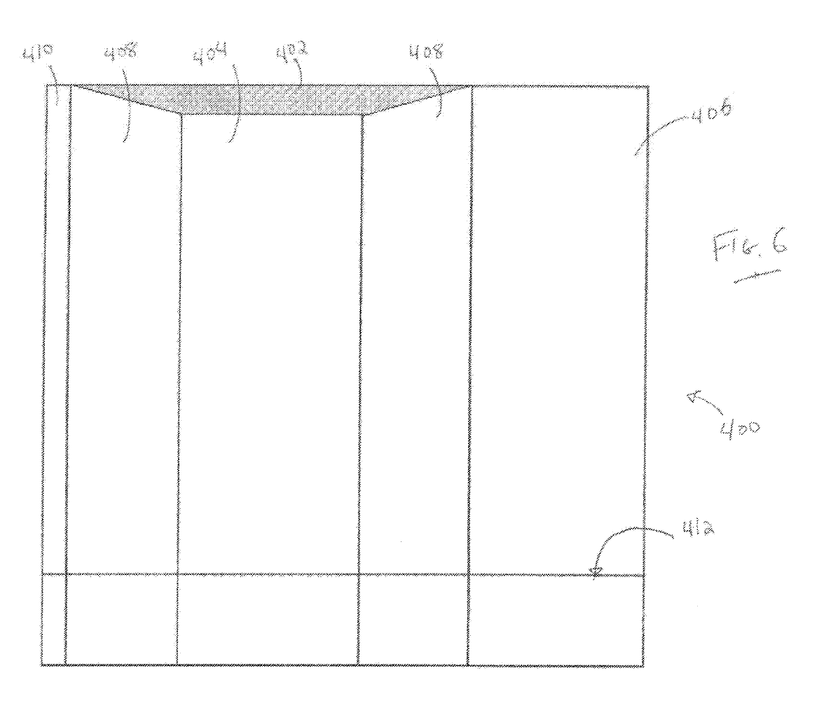

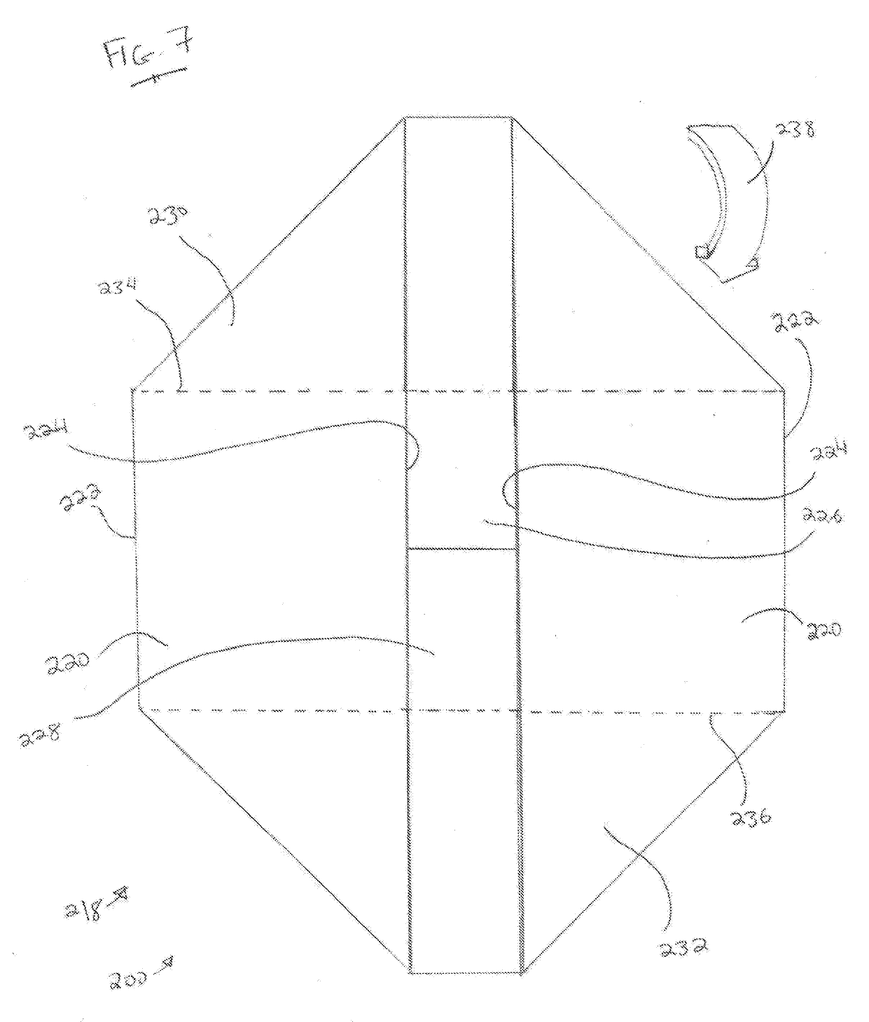

FIG. 5 shows a step cut die cut pattern suitable for use in manufacturing a bag of the disclosure, and FIG. 6 shows a Z cut pattern suitable for use in manufacturing a bag of the disclosure. Where die cutting of the top of the bag is desirable, in an embodiment the die cutting of the material occurs before the folding and sealing of the material into the gusseted tube of indefinite length. In this way, where a step cut or Z cut is to be on the final product bags, the gusseted tube of indefinite length will include a series of equally spaced apart die cuts corresponding to the unfolded die cut patterns of FIGS. 5 and 6. Alternatively, the die cutting of the tops of the bags may occur after each gusseted tube is cut into individual segments. In another embodiment, the die cutting may occur before the creation of the gusseted tube, at intermittent distances on a continuous length of material. In yet another embodiment, the die cutting may occur before the creation of a gusseted tube on individual panels of material that may then be formed into gusseted tubes.

It should be understood that die cutting of the patterns seen in FIGS. 5 and 6 is not intended to be limited strictly to literally die cutting of the material. Indeed, all cutting or other mechanisms for separation of the grayed areas shown in FIGS. 5 and 6, and cutting to produce other tops of bags, are embraced by this disclosure. Further, the dimensions and ratios seen in FIGS. 5 and 6 are not meant to be so limiting, as these figures are embodiments intended to show various configurations of the top of the bag. A bag of the disclosure may have any suitable width, length, height, etc. and still be embraced by the claims.

Specifically, in FIGS. 5 and 6, an area of material 400 into which a bag of the disclosure will be formed may receive one or more cuts to create a section of material to be removed 404 to generate the specific respective cut of the top of the eventual SOS bag. These figures additionally show fold lines that will eventually define the future front panel 404, the future back panel 406, and future gussets 408 of the bag. A region of future overlapping section 410 is also present, as seen in FIG. 3, which will include a portion of overlapping that results in the side seam that will define the gusseted tube of the disclosure. A future bottom fold line 412 that defines portions of the material that will eventually make the bottom of the bag runs the width of the area of material 400 is also shown in FIGS. 5 and 6.

Gusseted tubes as described herein include a bottom end that undergoes manipulations and sealings to create the bag of the disclosure, where the top end of the tube is the location that the cut pattern of FIG. 5 or 6, when applicable, would reside. The bags may be cut into segments of gusseted tubes which will then be manipulated and sealed to create the SOS bag of the disclosure. Where a flush cut is desired, cutting of the tube of indefinite length into individual segments will create the flush top of the bag.

An exemplary method of manufacturing a bag of the disclosure will now be described. In a preliminary step, a section of gusseted material as previously described herein is provided.

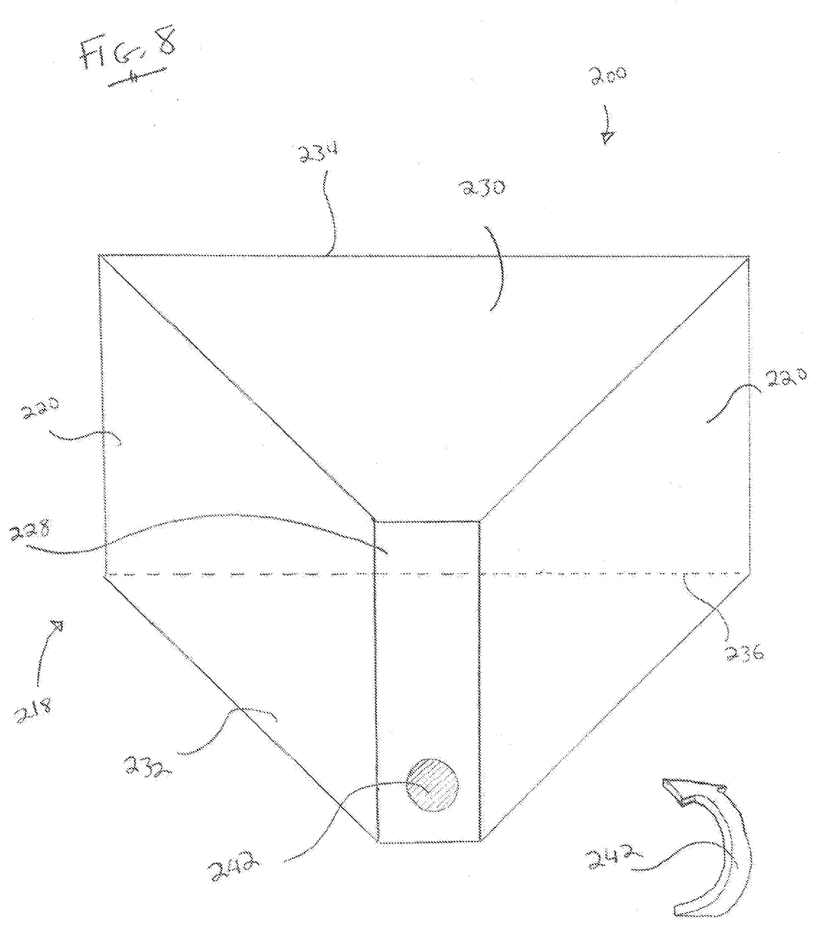

Turning further to the figures, FIG. 7 shows the gusseted tube 200 of FIG. 4, as viewed from the bottom 218. Here, in a first step, the bottoms 220 of the gussets are inwardly folded at gusset bottom fold lines 222 to create an octagonal shape seen in FIG. 7. In this embodiment, the bottom edges 224 of the respective gussets do not meet at the center of the bottom of the tube after folding. As a result, a portion of the bottom of interior wall 226 of the front panel and a portion of the bottom of the interior wall 228 of the rear panel can both be seen.

The inward folding of the gussets in FIG. 7 also creates the front flap 230 and the rear flap 232, which are defined as portions of the tube beyond, respectively, a front flap fold line 234 and a rear flap fold line 236. The front flap fold line and rear flap fold line are indicated by dashed lines in FIG. 7. Both the front flap 230 and the rear flap 232 in this embodiment are substantially identical isosceles trapezoids. FIG. 7 includes an arrow showing the direction of folding 238 the front flap 230 about the front flap fold line 234. In a second step, the front flap is folded about the front flap fold towards the interior of the bottom of the bag, onto portions of inwardly folded gussets, the lower interior of the front panel, and a portion of the lower interior of the rear panel.

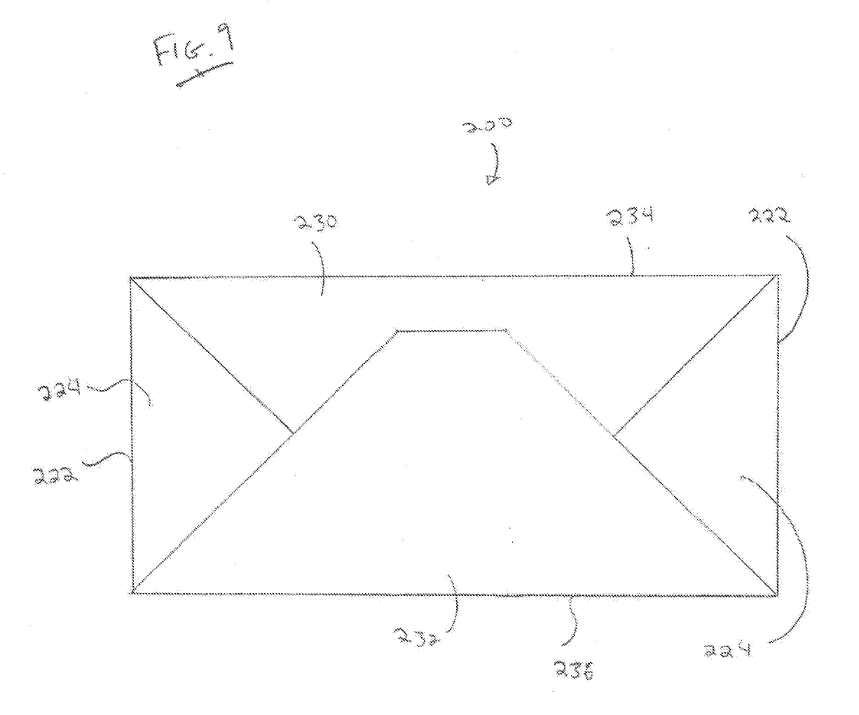

The result of the second step is seen in FIG. 8. In a third step, the gusseted tube 200 of FIG. 8 undergoes a further folding, where the rear flap 232 is folded about the rear flap fold line 236 towards the interior of the bottom 218 of the bag, onto portions of the inwardly folded gussets 220, the lower interior 228 of the rear panel, and a portion of the previously-folded front flap 230. FIG. 8 includes an arrow showing the direction of folding 240 the rear flap about the rear flap fold line.

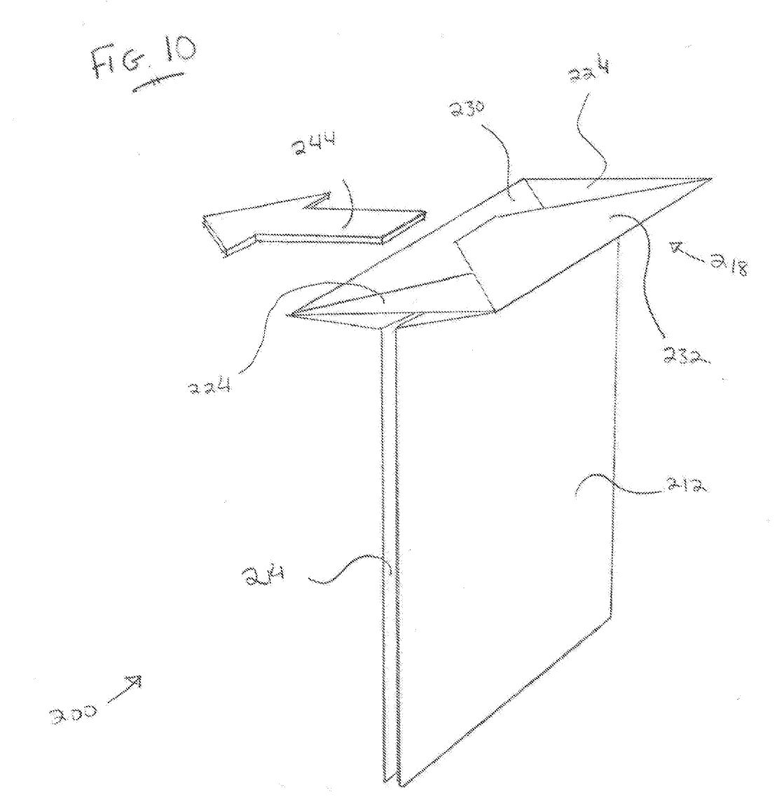

The result of this third step is the configuration seen in FIG. 9. This rectangular shape seen from the bottom of the tube 200 generally defines the perimeter of the bottom of the bag, defined by the gusset bottom fold lines 222, the front flap fold line 234, and the rear flap fold line 236.

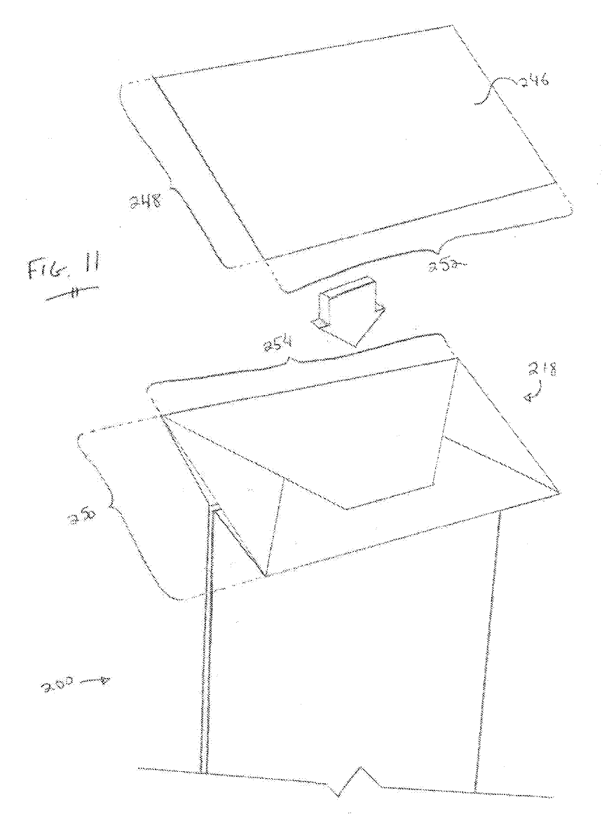

In an optional intermediary step between the aforementioned second and third steps, a spot 242 of hot melt adhesive or glue may be placed on the rear flap 232 prior to or in conjunction with the folding of the rear flap, so as to hold the flat bottom gusseted tube of FIG. 9 in a folded position. This spot 242, as shown in FIG. 8, of hot melt adhesive or glue would be non-functional in the final structure of the bag and would provide no sealing of the contents of the bag, but instead might provide a stabilizing element to hold the rear flap 232 in place, folded onto the front flap 230, as the bag is presented to the one or more sealing stations that follow, as will be seen in FIG. 10 and later figures.

It should be noted that where the terms “front” and “rear”, or “front” and “back”, are used herein, these need not necessarily be the literal front or back of the bag. These terms are merely being used herein to aid in describing the various steps of making the bag of the disclosure.

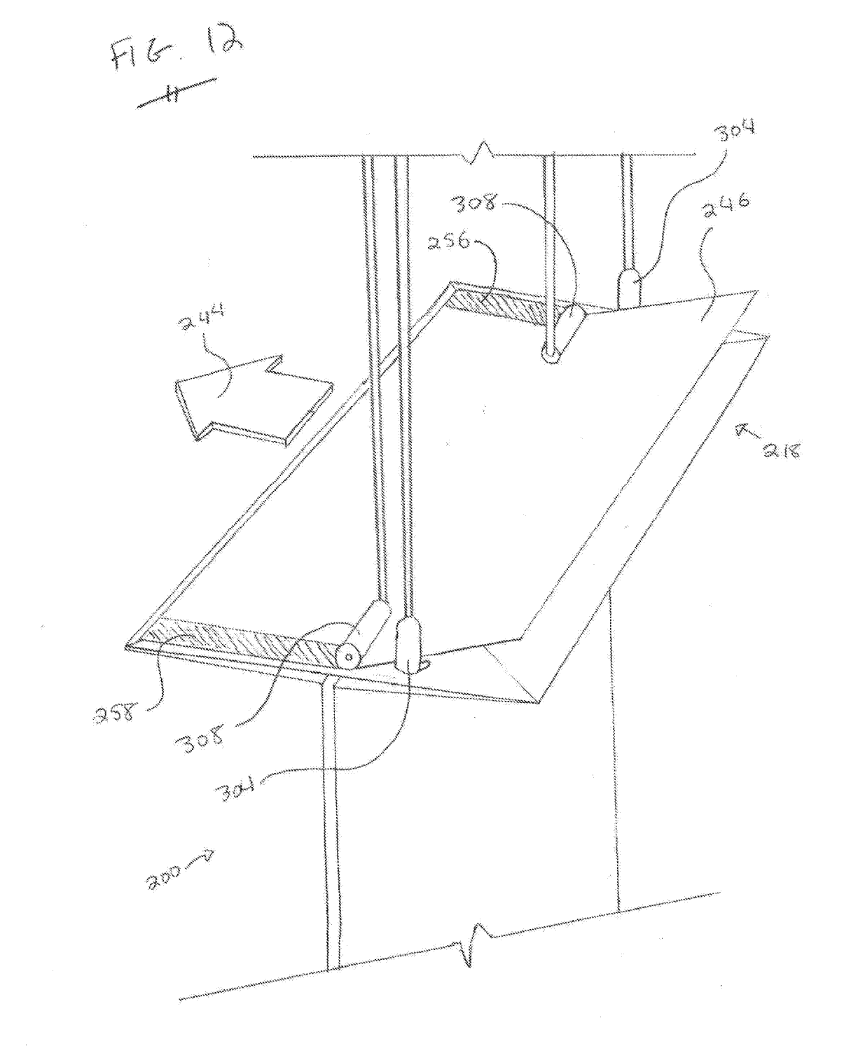

FIG. 10 shows the configuration and presentation of the bottom 218 of the gusseted tube 200 of FIG. 9 in a T shape, as it will be presented to a sealing apparatus in a first sealing direction 244, in an inverted position with the open end of the bag directed downward. FIG. 11 shows an embodiment of the presentation of a rectangular bottom patch 246 to the bottom 218 of the gusseted tube 200 of FIG. 10. In the embodiment of FIG. 11, the relative measurements of the length and width of both the patch and the bottom of the gusseted tube are seen, where the length 248 of the patch is slightly less than the length 250 of the bottom of the folded gusseted tube. Similarly, the width 252 of the patch is slightly less than the width 254 of the bottom of the folded gusseted tube.

In an embodiment, the patch is constructed of a material that is the same as the rest of the gusseted tube for the sake of continuity. So, where the gusseted tube is constructed of, for example, an inner layer of woven oriented polypropylene may be laminated to an outer layer of reverse printed oriented polypropylene to make an effectively single layer web of material, the patch may be made of the same material, and the woven side of the material may be the portion adhered to the bottom of the bag. Those of skill in the art will appreciate that the patch may be of different construction than the remainder of the tube, depending on the desires of the manufacturer.

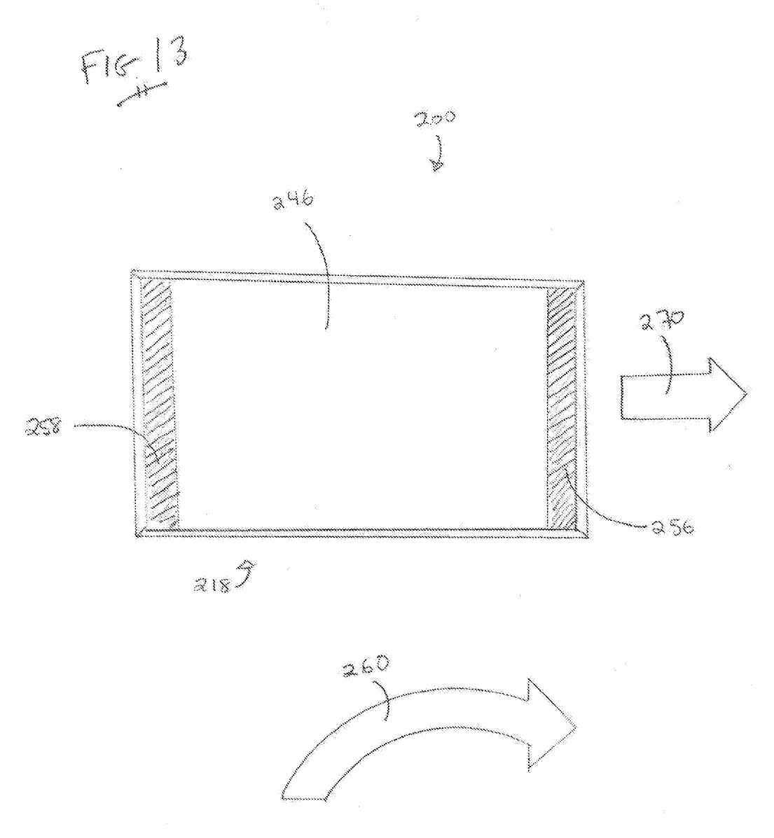

Turning to FIG. 12, the closed bottom gusseted tube 200 and patch 246 of FIG. 11 are together passed through a pair of stationary hot air sealing stations in a fourth step. In the fourth step of the method, the patch 246 is adhered to the closed bottom gusseted tube 200. In this embodiment of the fourth step seen in FIG. 12, the closed bottom gusseted tube and patch together travel in the first sealing direction 244 while a pair of nozzles 304 are selectively applying hot air to parallel sections of the outer underside portions of the patch 246, and a pair of stationary rollers 308 subsequently apply pressure to push the patch 246 against the folded bottom 218 of the gusseted tube 200, thereby creating first 256 and second 258 bottom seals, these seals 256, 258 designated by areas of hashed lines in FIG. 12. Though rollers 308 are shown, other compression mechanisms may be used to adhere the sections of at least now partially molten plastic on the underside of the patch 246 to the bottom 218 of the tube 200. Additionally, other adhesion mechanisms could be used to adhere the patch to the bottom of the tube.

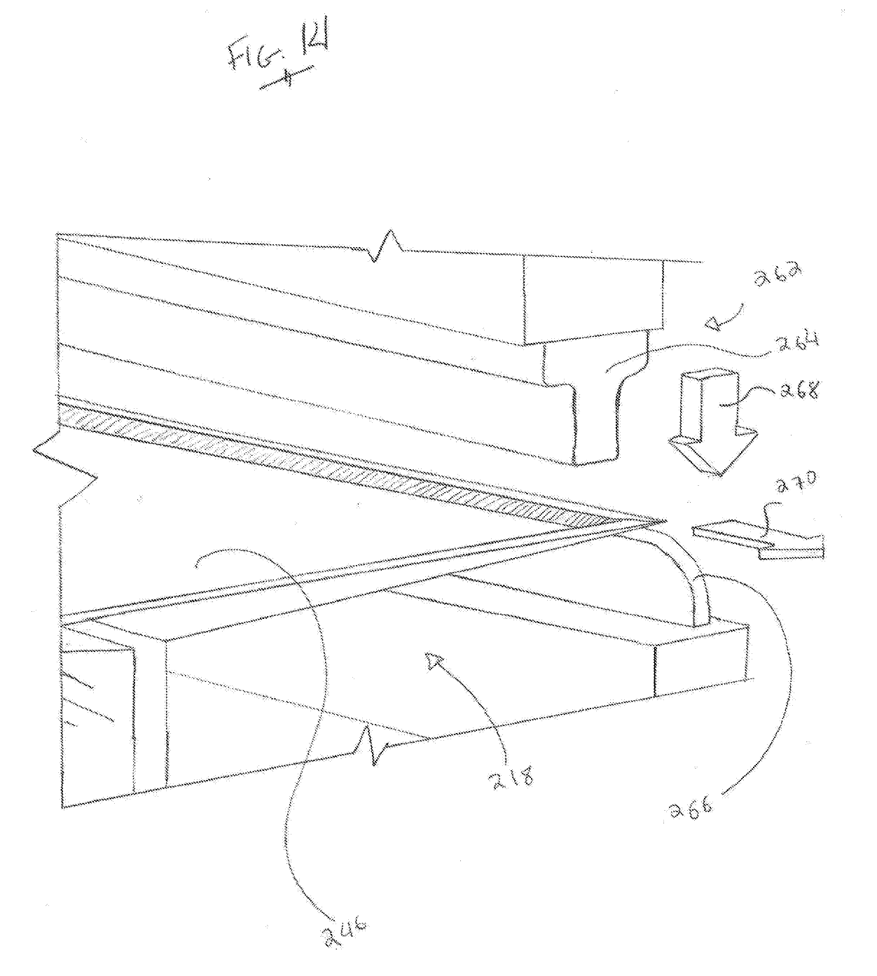

The result of the fourth step of FIG. 12 is the embodiment seen in FIG. 13, where two parallel heat seals 256, 258 have been applied to the patch 246 and bottom 218 of the tube on the gusset sides of the bottom 218 of the closed bottom tube 200. In this embodiment, the heat seals 258, 258 are of substantially equal width and length and run the full length 248 of the patch 246. Upon completion of the fourth step, the gusseted tube 200 and patch 246 may be rotated ninety degrees 260 en route to or in conjunction with preparing for the next step of the process. Having been rotated ninety degrees, the tube and patch travel in a second sealing direction 270.

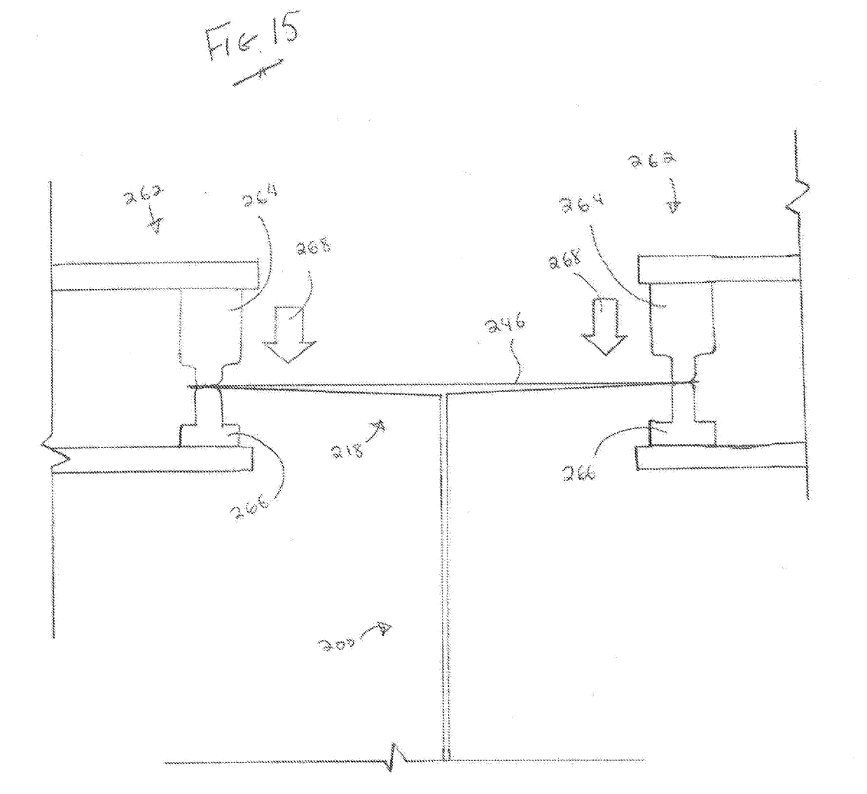

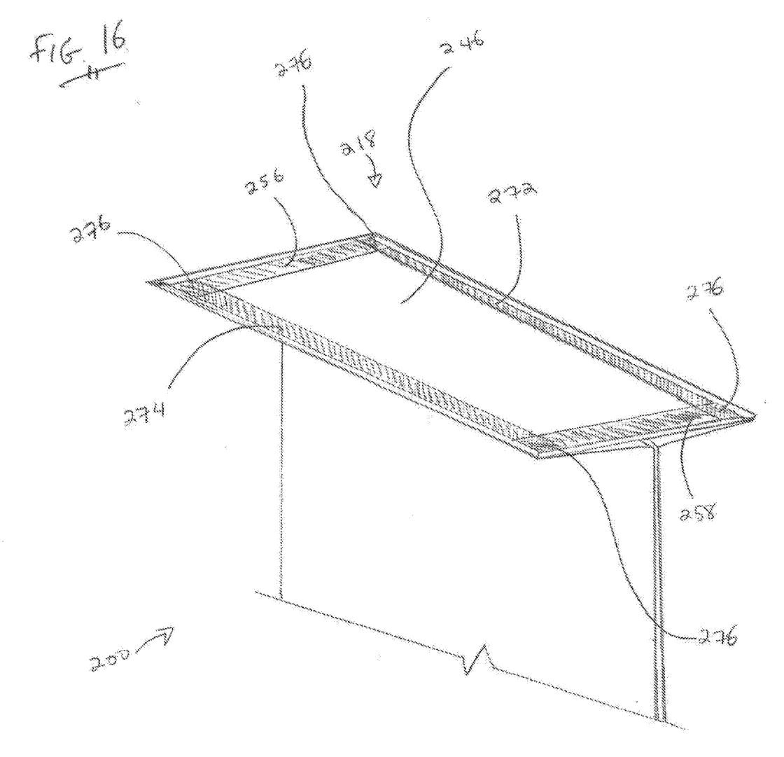

FIG. 14 includes a detail of an embodiment of an ultrasonic weld station 262 that may be used in a fifth step of this process, where the patch 246 and folded bottom 218 of the gusseted tube are presented to an ultrasonic welding station. Here, an ultrasonic weld station 262 includes a horn 264 and an anvil 266, where the widths 252, 254 of the bottom of the gusseted tube 200 and corresponding patch 246 are first introduced to and then may be pressed between a horn 264 and anvil 266. In this embodiment, the horn moves downwardly in an ultrasonic sealing direction 268 to apply the compression. When compressed, the horn vibrates at a high frequency while steady pressure is applied across the width of the patch. The high-frequency ultrasonic acoustic vibrations to the patch to create a solid-state weld between the patch and the folded portions of the bottom of the gusseted tube. A portion of a heat seal is designated by areas of hashed lines in FIG. 14, which does not include any indication of the aforementioned first and second heat seals for the sake of clarity. FIG. 15 shows a profile view of an embodiment of a pair of ultrasonic welding stations compressing in the ultrasonic sealing direction onto the bottom of the folded gusseted tube to create two parallel seals along the widths of the patch, one each near and parallel to the front flap fold line and the rear flap fold line.

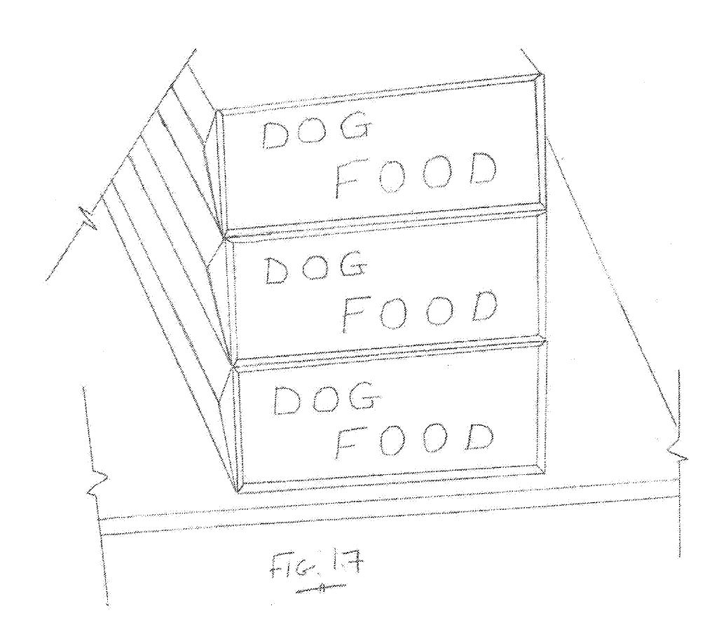

The result of the fifth step seen in FIGS. 14 and 15 is the creation of third 272 and fourth 274 bottom seals. As seen in FIG. 16, the patch 246 has now been applied around its perimeter to the folded bottom 218 of the gusseted tube 200 to complete an embodiment of a method of making a bag of the disclosure, these four heat seals 256, 258, 272, 274 designated by areas of hashed marking. The first and second seals overlap the third and fourth seals at the four corners 276 of the patch.

The completed gusseted bag of the disclosure, as seen now from the bottom in FIG. 16, having undergone the previous steps, may now continue past the ultrasonic welding mechanism to be prepared for shipment to a consumer, for example. Bags of the disclosure may be filled and stacked on shelving with the bottom flap outwardly visible towards consumers, an embodiment of which can be seen in FIG. 17.

An SOS bag of the disclosure manufactured via the foregoing method will now resemble the prior art SOS bag of FIGS. 1 and 2, with the distinction that the bottom of the bag of the disclosure includes a unique construction manufactured via a unique method.

Comparing the sealing methods used in FIG. 13 for the first and second bottom seal and in FIGS. 14 and 15 for the third and fourth bottom seal, the geometry of the bag dictated those methods. A hot air welding apparatus as seen in FIG. 13, for example, can be applied entirely on one side of a substrate, which in this example is the bottom of the bag along the gussets. The hot air welding method includes a continuous flow of two distinct substrates into one, those being the flap and the folded bottom of the bag in FIG. 13, and the two overlapping portions of the material in FIG. 3. Conversely, the ultrasonic welding method requires pressure on both sides of the two substrates being adhered. This method would not be suitable for gusseted sides of a bag due to the descending body of the bag when the bag is in the T presentation of FIG. 10, though the folding of the flaps permit the use of ultrasonic welding once the bag has been turned ninety degrees after the hot air welding step. Additionally, once a first pair of parallel seals has been applied, the patch has no loose corners to lift in order to apply the hot air welding, hence the use of ultrasonic welding for the second pair of parallel seals.

In an embodiment of a heat sealing mechanism of the disclosure, the embodiment includes a nozzle for selectively applying hot air to a portion of the material and a subsequent roller to apply pressure to push two portions of material together to create the heat seal. In this mechanism, there is a direction which the material travels, while the heat sealing mechanism remains stationary, for example as one of a plurality of stations on a manufacturing line.

Where hot air heat sealing is used, the heat applied to the substrate will vary based on several factors, including the speed of manufacture in bags per minute and the material being heat sealed. The pressure required to effectuate the heat seal by pressing the at least partially molten material onto another substrate will also be determined by the speed of manufacture of the bags, the material being sealed, and the temperature of the hot air. The specific settings for the heat, speed, pressure, etc. may be calibrated on an individual basis on each machine and will vary from one machine to another, and from one process to another. Generally, though, hot air heat sealing stations may operate at a temperature range of 100 to 1,500 degrees Fahrenheit, although to make bags relatively quickly a higher range of 500 to 1,500 degrees may be preferred. Specific tolerances will vary by machine and substrate, but can typically fluctuate 25 degrees above or below the ideal conditions for bag manufacture and still make a quality product, based on a desired bag manufacturing speed. Many modern machines can manufacture bags at a rate of 60 to 80 large bags, such as those capable of holding bulky dog food, per minute, with higher end machines producing up to 100 per minute. As the speeds increase, so will the heat of the hot air and the corresponding pressure of the rollers. With bags moving faster down an assembly line, the hot air must be increased to compensate for the reduced time of exposure of the substrate to the hot air. The same may be said for any compression rollers, which might need additional pressure as bags move faster past the hot air sealing station.

Similarly, where ultrasonic welding takes place as a part of the manufacturing process, the desired speed of manufacturing of the bags will govern the vibration frequency and pressure between the horn and anvil for each bag. Where an ultrasonic station must operate more quickly, the vibration frequency and pressure may be increased. Additionally, where the substrate demands, the specific settings of the ultrasonic welding station or stations. In determining the proper temperature of ultrasonic welding in some instances, for example in FIGS. 14 and 15, it is important to provide only enough vibration and pressure to adhere the patch to the bottom of the bag, and not to seal the bottom of the bag to itself, through the patch, the folded flap, and through the lower portion of the bag wall, as this would result in a non-functional bag that does not open properly at its bottom.

The result of the ultrasonic and hot air seals on the bottom of the bag are a perimeter of the patch adhered to the flat folded bottom of the gusseted tube, such that the seals, the patch, and the folded tube together create complete seal and barrier between the eventual contents of the bag and the outside environment.

It will be appreciated by those of skill in the art that the various steps disclosed herein may be conducted by machinery in one or more manufacturing machines, and those machines may include a variety of tracks, wheels, rollers, and other known bag manufacturing machine components, including mechanisms to transfer the bag along the machine from beginning to end and between individual stations, such as sealing stations. Indeed, one could manufacture a bag of the disclosure at least partially by hand, escorting the gusseted tube from one station to another, such as individual sealing machines, or by making the bag of the disclosure on one or more manufacturing machines. All possible configurations of bag manufacturing machines that could be conceived by one of skill in the art that assemble a bag of the disclosure or practice the method of this disclosure are thus embraced by this disclosure, and this disclosure should not be limited to a single manufacturing machine with only the stations described herein.

The size of the rectangular flat bottom patch relative to the perimeter of the bottom of the bag, specifically the embodiment seen in FIG. 11 where the patch is slightly smaller in width and length than the corresponding measurements of the bottom of the bag, is in part due to the nature of the material from which the gusseted tube may be constructed. Plastic film, by its nature, has memory as a property. By memory, it is understood that plastic film wants to return to its original planar structure and doesn't provide the crisp, clean ninety degree folds that a paper material, for example, might provide. So where the gusseted bag is constructed of a substantially plastic material, such as for example an effectively single ply constructed by laminating an inner woven oriented polypropylene layer with a reverse printed oriented polypropylene film layer, long folds of this material will not have totally crisp ninety degree folds that retain their shape at the same level as a paper bag, such as the brown paper lunch sack discussed earlier herein. Because plastic has memory, the various folds of the gusseted tube and additionally the finished product gusseted SOS bag of the disclosure will not be sharp bends, but rather very subtle curves at the folds. Even after folding along a crease, the plastic material will try, even if only slightly so, to curve back into a plane. When applying the flat bottom patch and sealing it to complete the bottom of the bag, having the outer edges of the patch flush with outer edges of the bottom of the bag might not result in as effective of a seal because of the memory of the plastic at those bends of the gussets and flaps into the bottom of the bag. The outer edges of the patch in that instance might not adhere to the rest of the bottom of the bag while the folded plastic around the bottom edges of the bag is attempting to return to a planar shape. Instead, by having the patch width and length be near, but not at, the same dimensions of the bottom of the bag, the outer edges of the patch may be tightly sealed against the bottom of the bag, resulting in a more complete seal. Ideally, in order to achieve the largest display area possible, one would like to have the patch dimensions align with the folds that separates the bottoms of the gussets from the back panel, but plastic memory prevents this level of efficiency.

Bags of the disclosure provide several advantages over conventional bags of the prior art. For example, in the packaging of pet food, bags of the disclosure have various specific benefits. Pet food, including dry dog food, can be a greasy and heavy product. In the past, the packaging industry had embraced the use of paper-based or paper composite bags for dog food. However, at as the size of the bag, and thus the weight and volume of the dog food contained therein, increased, consumers and retailers were met with more frequent failures of the bag integrity, resulting in loss of product, mess in the retail environment, and negative consumer experiences.

As the industry shifted away from paper-based bag construction, woven oriented polypropylene became more favored, due to its substantially improved strength, particularly its resistance to puncture. Dog food became increasingly stored in bags constructed of a ply of woven oriented polypropylene (OPP) laminated with a layer of reverse printed plastic film, with the woven OPP on the inside of the bag against the food. These bags, by virtue of the construction material, in some instances provided less flexibility and less opportunity for attractive printing. Many of these large woven OPP were rolled and heat sealed on the bottom, which did not provide an attractive or particularly useful area for the dog food company to print. Large, heavy bags of pet food (or other goods) tend to lay on their sides in a retail environment, giving increased value to the bottom of the bags for printing.

Bags of the present disclosure, however, attempt to overcome the failures of the art. Bags disclosed herein allow the printing of logos and other information to attract consumers on the bottom of the bag in a clean, consistent manner on a substantially congruent surface. Bags can be stored laying down with the bottom-out and facing consumers, allowing for more product to be stored on shelves. Additionally, the rectangular bottoms of the bags, paired with the gusseted shape of a traditional SOS bag body, will allow tighter stacking of bags of product, both on top of each other and in adjacent columns of product. These and other advantages associated with the bags of the present disclosure will be apparent to those of ordinary skill in the art.

Thus a flat bottomed gusseted SOS bag has been disclosed, as well as a method of manufacturing the same. Bags of the disclosure may include a gusseted bag having a front and back panel joined by gussets, where the bottom of the SOS bag includes a pair of inwardly folded gussets, and inwardly folded front and back flaps to create a folded bottom. This bag may further include a patch applied thereto on the folded bottom, where heat seals have been effected around the perimeter of the patch and folded bottom to create a substantially complete seal to the bottom of the bag. The patch and folded bottom may be complementary in shape, and the patch may be slightly less in width and in depth than the folded bottom. The top of the bag may contain any type of suitable closure or reclosure mechanisms known in the art, and the top of the bag may be open or closed, and may include a flush cut, step cut, or Z cut. Bags of the disclosure may be constructed of a variety of materials, including a co-laminated effectively single ply of woven oriented polypropylene and reverse printed oriented polypropylene, or other various constructions known in the art. Bags of the disclosure may include printing on the bottom of the bag, on the patch of the bag, to provide a legible display for consumers.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention as well as all equivalents thereof.

I claim:

1. A gusseted bag comprising a front panel and rear panel joined by a pair gussets, the front panel, rear panel, and gussets each having respective bottom edges, the bag having an interior cavity,
wherein the gussets are inwardly folded along gusset bottom fold lines such that the bottom edges of the gussets do not meet when folded,
the bag further comprising a front flap and a rear flap, wherein the front flap is a portion of the folded gussets and the front panel beyond a front flap fold line, and wherein the rear flap is a portion of the gussets and the rear panel beyond a rear flap fold line,
wherein the front flap is folded about the front flap fold line onto the inwardly folded gussets, and wherein the rear flap is folded about the rear flap fold line onto the inwardly folded gussets and rear flap,
the bag having a rectangular bottom defined by the gusset bottom fold lines, the front flap fold line, and the rear flap fold line, the bottom having both a length and width defined by the aforementioned fold lines,
wherein the bag further comprises a rectangular patch having a perimeter, the patch sealed to the bottom of the bag around the perimeter of the patch.

2. The gusseted bag of claim 1, wherein the gussets, the front panel, and the rear panel each has a respective width, and wherein the patch comprises both a length and width, the width of the patch being shorter than the widths of the front and rear panel, and the length of the patch being shorter than the widths of the gussets.

3. The gusseted bag of claim 2, wherein the perimeter of the patch is not flush with any of the gusset bottom fold lines, the front flap fold line, and the rear flap fold line.

4. The gusseted bag of claim 1, further comprising a seal on the rear flap to hold the rear flap onto the front flap.

5. The gusseted bag of claim 1 wherein the bag further comprises a top end, wherein the top end comprises a cut pattern selected from the group consisting of a Z cut, a flush cut, and a step cut.

6. The gusseted bag of claim 1 wherein the bag is constructed of an effectively single ply plastic laminate comprising a layer of woven plastic laminated to a layer of plastic film.

7. The gusseted bag of claim 6, wherein the woven plastic is woven oriented polypropylene and the plastic film is reverse-printed plastic.

8. The gusseted bag of claim 1, wherein the front panel, the rear panel, the gussets, and the patch are all constructed of the same material.

9. The gusseted bag of claim 1, wherein the patch is sealed to the bottom of the bag around the perimeter of the patch a first, second, third, and fourth seal, the first and second seals being effected via selective hot air sealing, and the third and fourth seals being effected via ultrasonic welding,
wherein the first and second seals are adjacent to the gusset fold lines, the third seal is adjacent to the front flap fold line, and the fourth seal is adjacent to the rear flap fold line.

10. A gusseted bag comprising a front panel and rear panel joined by a pair gussets, the front panel, rear panel, and gussets each having respective bottom edges, the bag having an interior cavity,
wherein the gussets are inwardly folded along gusset bottom fold lines such that the bottom edges of the gussets do not meet when folded,
the bag further comprising a front flap and a rear flap, wherein the front flap is a portion of the folded gussets and the front panel beyond a front flap fold line, and wherein the rear flap is a portion of the gussets and the rear panel beyond a rear flap fold line,
wherein the front flap is folded about the front flap fold line onto the inwardly folded gussets, and wherein the rear flap is folded about the rear flap fold line onto the inwardly folded gussets and rear flap,
the bag having a rectangular bottom defined by the gusset bottom fold lines, the front flap fold line, and the rear flap fold line, the bottom having both a length and width defined by the aforementioned fold lines,
wherein the bag further comprises a rectangular patch having a perimeter, the patch sealed to the bottom of the bag around the perimeter of the patch,
wherein the gussets, the front panel, and the rear panel each has a respective width, and wherein the patch comprises both a length and width, the width of the patch being shorter than the widths of the front and rear panel, and the length of the patch being shorter than the widths of the gussets, and the perimeter of the patch is not flush with any of the gusset bottom fold lines, the front flap fold line, and the rear flap fold line,
bag and patch are both constructed of an effectively single ply plastic laminate comprising a layer of woven plastic laminated to a layer of plastic film.

11. The gusseted bag of claim 1, wherein the patch is sealed to the bottom of the bag around the perimeter of the patch a first, second, third, and fourth seal, the first and second seals being effected via selective hot air sealing, and the third and fourth seals being effected via ultrasonic welding,
wherein the first and second seals are adjacent to the gusset fold lines, the third seal is adjacent to the front flap fold line, and the fourth seal is adjacent to the rear flap fold line.

12. A method of manufacturing a gusseted bag comprising the steps of
first providing a gusseted tube of material of indefinite length, the tube comprising a front panel and a back panel joined by two gussets and having an interior cavity and a top and a bottom, wherein the front panel, rear panel, and gussets each has respective bottom edges at the bottom of the tube, and
in a second step, folding the bottoms of the gussets about gusset bottom fold lines inwardly towards the cavity such that the bottom edges of the gussets do not meet when folded,
in a third step, where the tube further comprises a front flap, wherein the front flap is a portion of the folded gussets and the front panel beyond a front flap fold line, folding the front flap about the front flap fold line onto the inwardly folded gussets,
in a fourth step, where the tube further comprises a rear flap, wherein the rear flap is a portion of the gussets and the rear panel beyond a rear flap fold line, folding the rear flap about the rear flap fold line onto the inwardly folded gussets and rear flap,
in a fifth step, where the tube further comprises a rectangular bottom defined by the gusset bottom fold lines, the front flap fold line, and the rear flap fold line, the bottom having both a length and width defined by the aforementioned fold lines, sealing a rectangular patch, the patch having a perimeter, to the bottom of the bag around the perimeter of the patch.

13. The method of claim 12, wherein the gussets, the front panel, and the rear panel each has a respective width, and wherein the patch comprises both a length and width, the width of the patch being shorter than the widths of the front and rear panel, and the length of the patch being shorter than the widths of the gussets.

14. The method of claim 13, wherein the perimeter of the patch is sealed to the bottom such that it is not flush with any of the gusset bottom fold lines, the front flap fold line, and the rear flap fold line.

15. The method of claim 12, further comprising a step between the third and fourth step of applying a seal on the rear flap to hold the rear flap onto the front flap when the rear flap is folded in the fourth step.

16. The method of claim 12 wherein the tube further comprises a top end, wherein the top end comprises a cut pattern selected from the group consisting of a Z cut, a flush cut, and a step cut.

17. The method of claim 12 wherein the bag is constructed of an effectively single ply plastic laminate comprising a layer of woven plastic laminated to a layer of plastic film.

18. The method of claim 17, wherein the woven plastic is woven oriented polypropylene and the plastic film is reverse-printed plastic.

19. The method of claim 12, wherein the front panel, the rear panel, the gussets, and the patch are all constructed of the same material.

20. The method of claim 12, wherein, during the fifth step, the patch is sealed to the bottom of the bag around the perimeter of the patch a first, second, third, and fourth seal, the first and second seals being effected via selective hot air sealing, and the third and fourth seals being effected via ultrasonic welding,
where the first and second seals are applied before the third and fourth seals are applied,
wherein the first and second seals are adjacent to the gusset fold lines, the third seal is adjacent to the front flap fold line, and the fourth seal is adjacent to the rear flap fold line.
